(19) United States
(12) Patent Application Publication
(10) Pub. No.: US 2024/0190016 A1
(43) Pub. Date: Jun. 13, 2024

(54) APPARATUSES AND METHODS FOR SURFACE CLEANING

(71) Applicant: ECAC, Inc., Bellevue, WA (US)

(72) Inventors: Yiwen XIN, Woodinville, WA (US); Yuxiong CAO, Lake Stevens, WA (US); Zihao XU, Bellevue, WA (US); Ge TAO, Bellevue, WA (US)

(73) Assignee: ECAC, Inc., Bellevue, WA (US)

(21) Appl. No.: 18/539,097

(22) Filed: Dec. 13, 2023

Related U.S. Application Data
(60) Provisional application No. 63/432,334, filed on Dec. 13, 2022.

(51) Int. Cl. B25J 11/00; B25J 5/00; B25J 9/16

(52) U.S. Cl. CPC B25J 11/0065; B25J 5/007; B25J 9/161; B25J 9/1664

(57) ABSTRACT

Cleaning apparatuses and methods for cleaning object surfaces are provided. The cleaning apparatus may include a tool box, including at least one processor configured to receive scanning data and generate working paths for the cleaning apparatus, and an energy source disposed inside the tool box to supply power to the cleaning apparatus and at least one active contact flange, connecting to the tool box and configured to provide active contact and constant force in a working state, each of the at least one active contact flange configured to control at least one orbital kit to clean the high-speed vehicle.

### CROSS-REFERENCE TO RELATED APPLICATION

The application is based upon and claims priority to U.S. Provisional Application No. 63/432,334, entitled “Apparatuses and Methods for Surface Cleaning,” filed on Dec. 13, 2022, the entire content thereof is incorporated herein by reference in its entirety for all purposes.

### TECHNICAL FIELD

This disclosure is related to cleaning apparatuses and methods. More specifically, this disclosure relates to methods and devices for sanding, polishing or waxing large surfaces of a high-speed vehicle.

### BACKGROUND

Surface cleaning, sanding, polishing and waxing, especially for large exterior surfaces, are usually done manually, which requires extended cleaning time and high labor cost. When the process is done manually, it is also difficult to ensure a high quality of work consistently. In addition, many of the cleaning processes require using acidic chemicals to remove stubborn stains on object surfaces, such as cars, vans, train cars, aircrafts, boats, wind turbine blades, etc. Such chemicals may not only further pollute our environment, pose a danger to the health of the operators, but also damage the top layer paint of the object to be cleaned. The gloss to the painted surfaces may also fade quickly due to the cleaning chemicals.

### SUMMARY

Examples of the present disclosure provide apparatus and methods for cleaning exterior surfaces.

According to a first aspect of the present disclosure, a cleaning apparatus is provided. The cleaning apparatus may include: a tool box, comprising at least one processor configured to receive scanning data and generate working paths for the cleaning apparatus, and an energy source disposed inside the tool box to supply power to the cleaning apparatus; and at least one active contact flange, connecting to the tool box and configured to provide active contact and constant force in a working state, each of the at least one active contact flange configured to control at least one orbital kit to clean the high-speed vehicle.

According to a second aspect of the present disclosure, an automated system is provided. The automated system may include: one or more sensors to scan object surfaces of a high-speed vehicle and obtain scanning data of the object surfaces; a carrier to carry and lift a cleaning apparatus for sanding, polishing and waxing; and the cleaning apparatus as disclosed in the first aspect of the present disclosure.

According to a third aspect of the present disclosure, a method for cleaning object surfaces is provided. The method may include: providing one or more sensors to scan object surfaces of a high-speed vehicle and obtain scanning data of the object surfaces; controlling a carrier to carry and lift a cleaning apparatus for sanding, polishing and waxing; providing a tool box, comprising at least one processor configured to receive scanning data and generate working paths for the cleaning apparatus, and an energy source disposed inside the tool box to supply power to the cleaning apparatus; and controlling at least one active contact flange to provide active contact and constant force in a working state, wherein each of the at least one active contact flange is configured to control at least one orbital kit to clean the high-speed vehicle.

It is to be understood that the above general descriptions and detailed descriptions below are only exemplary and explanatory and not intended to limit the present disclosure.

### BRIEF DESCRIPTION OF THE DRAWINGS

The accompanying drawings, which are incorporated in and constitute a part of this specification, illustrate examples consistent with the present disclosure and, together with the description, serve to explain the principles of the disclosure.

FIG. 1 illustrates a perspective view of the cleaning apparatus in accordance with some implementations of the present disclosure.

FIG. 2 illustrates a perspective view of the cleaning apparatus without toolbox cover in accordance with some implementations of the present disclosure.

FIG. 3 illustrates a perspective view of a tool box frame in accordance with some implementations of the present disclosure.

FIG. 4 illustrates a side view of the cleaning apparatus in accordance with some implementations of the present disclosure.

FIG. 5 illustrates a side view of the cleaning apparatus in accordance with some implementations of the present disclosure.

FIG. 6 illustrates a perspective view of the cleaning apparatus in accordance with some implementations of the present disclosure.

FIG. 7 illustrates a perspective view of the cleaning apparatus in accordance with some implementations of the present disclosure.

FIG. 8 illustrates a perspective view of the cleaning apparatus in accordance with some implementations of the present disclosure.

FIG. 9 illustrates a perspective view of the cleaning apparatus in accordance with some implementations of the present disclosure.

FIG. 10 illustrates a perspective view of the cleaning apparatus in accordance with some implementations of the present disclosure.

FIG. 11 illustrates a side view of the cleaning apparatus in accordance with some implementations of the present disclosure.

FIG. 12 illustrates a perspective view of the cleaning apparatus in accordance with some implementations of the present disclosure.

FIG. 13 illustrates a side view of the cleaning apparatus in accordance with some implementations of the present disclosure.

FIG. 14 illustrates a perspective view of the automated system with a carrier in accordance with some implementations of the present disclosure.

FIG. 15 is a block diagram illustrates a method for cleaning object surfaces in accordance with some implementations of the present disclosure.

FIG. 16 illustrates a side view of a cleaning apparatus in accordance with some implementations of the present disclosure.

FIG. 17 illustrates a side view of a cleaning apparatus in accordance with some implementations of the present disclosure.

FIG. 18 illustrates a top view of a cleaning apparatus in accordance with some implementations of the present disclosure.

FIG. 19 illustrates a side view of a cleaning apparatus in accordance with some implementations of the present disclosure.

FIG. 20 illustrates a perspective view of a cleaning apparatus in accordance with some implementations of the present disclosure.

FIG. 21 illustrates a perspective view of a cleaning apparatus in accordance with some implementations of the present disclosure.

FIG. 22 illustrates a perspective view of a cleaning apparatus in accordance with some implementations of the present disclosure.

FIG. 23 illustrates a side view of an angle adjustment mechanism in accordance with some implementations of the present disclosure.

FIG. 24 illustrates a perspective view of an angle adjustment mechanism in accordance with some implementations of the present disclosure.

FIG. 25 illustrates a side view of an angle adjustment mechanism in accordance with some implementations of the present disclosure.

FIG. 26 illustrates a side view of an angle adjustment mechanism in accordance with some implementations of the present disclosure.

FIG. 27 illustrates a side view of an angle adjustment mechanism in accordance with some implementations of the present disclosure.

FIG. 28 illustrates a side view of an angle adjustment mechanism in accordance with some implementations of the present disclosure.

### DETAILED DESCRIPTION

Reference will now be made in detail to example embodiments, examples of which are illustrated in the accompanying drawings. The following description refers to the accompanying drawings in which the same numbers in different drawings represent the same or similar elements unless otherwise represented. The implementations set forth in the following description of example embodiments do not represent all implementations consistent with the disclosure. Instead, they are merely examples of apparatuses and methods consistent with aspects related to the disclosure as recited in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

In the present disclosure, a new device and method are presented, which employs physical method to replace chemical method to clean large surfaces, such as the exterior surfaces of a high-speed train vehicle, etc. The proposed apparatus also adopts automated system to improve efficiency and quality control. The automated system may include several sub-systems, such as a scan system, a carrier, active contact flange (ACF), orbital kits, collaborative robots (COBOT), Central Processing Unit, etc.

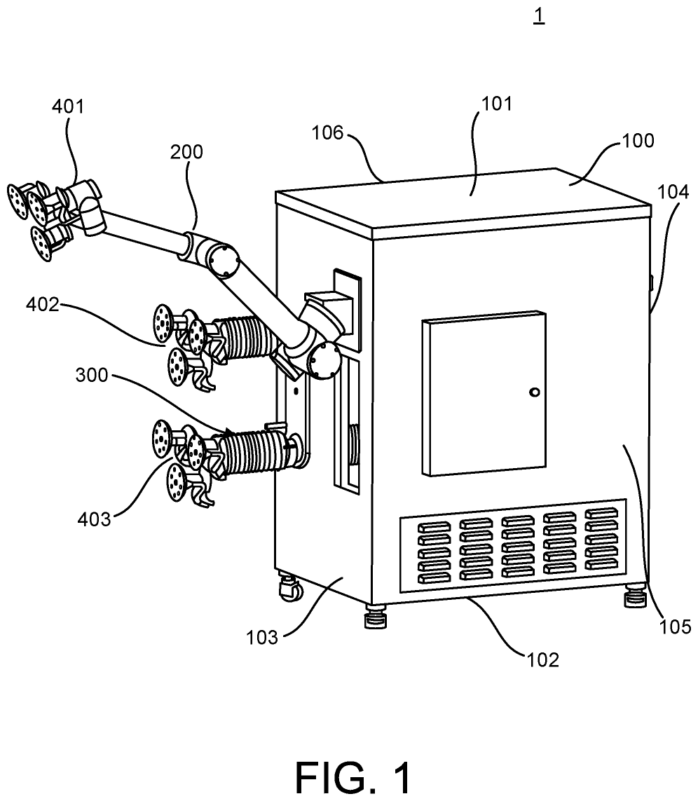

FIG. 1 illustrate a cleaning apparatus 1 in accordance with one example of the present disclosure. In general, the cleaning apparatus 1 includes a tool box 100, a robot arm 200, an active contact flange 300, and multiple orbital kits 400. The robot arm 200 and the active flange 300 are connect to a same side of the tool box 100, and extend towards a direction away from the tool box 100. The orbital kits 400 are connected to one end of the robot arm 200 or the active contact flange 300.

In one example, the tool box 100 is in a cuboid shape with six sides. Each of the six sides is of rectangular shape. The top and bottom sides 101, 102 are opposite to each other, and are connected by other four side walls, 103, 104, 105, 106. The first and the second side walls 103, 104 are opposite to each other, and connect the longer side of the top and the bottom sides 101, 102 of the tool box. The third and the fourth side walls 105, 106 are opposite to each other, and connect the shorter side of the top and bottom sides 101, 102 of the tool box. Both of the robotic arm 200 and the active contact flange 300 are connected to one side wall of the tool box. For one example, as shown in FIG. 1, the robotic arm 200 and the active contact flange 300 are both attached onto the first side wall 103, which connects two shorter side of the top and bottom side of the tool box.

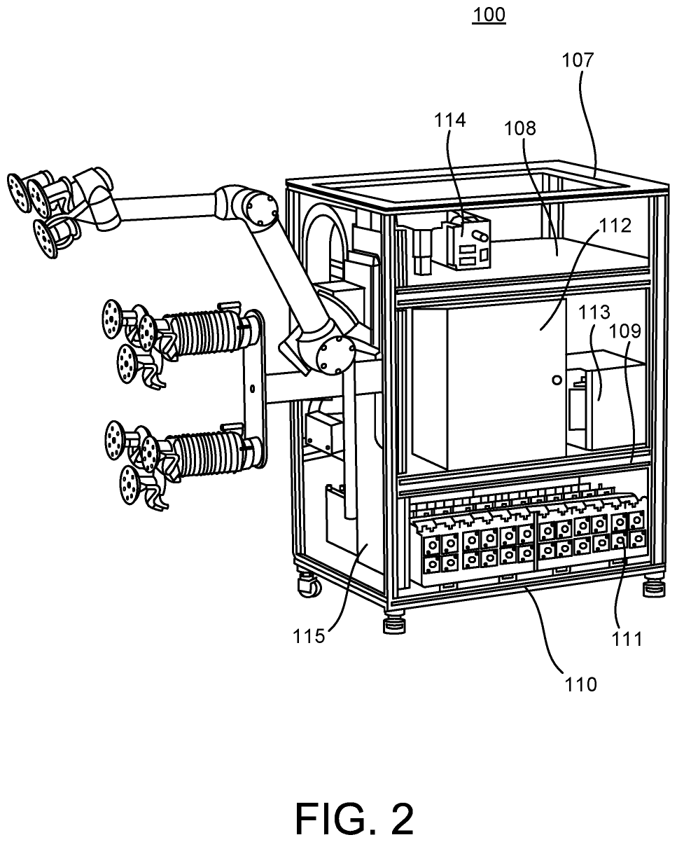

FIG. 2 is a perspective view of the cleaning apparatus without tool box cover, and illustrates the inside structure of the tool box 100 according to one example of the disclosure. During the operation of the cleaning apparatus 1, the tool box 100 serves as a central control of the movements of the robot arm 200 and the active contact flange 300. There is at least one processor installed in the tool box 100, and the processor is configured to receive scanning data and generate working paths for the cleaning apparatus. Scanning data carries various information of a target surface to be cleaned, and the scanning data is sent to the processor before or during the cleaning process. After receiving the scanning data, the processor would process it and generate a working path for the cleaning apparatus to clean the target surface. The working path may include information about how the robot arm 200 and the active contact flange 300 would move during the cleaning process.

The tool box 1 may include a skeleton frame 107 having a plurality of racks 108, 109, and 110 inside. In one example, the bottom rack 110 is configured to accommodate an energy source 111, which may include a plurality of rechargeable batteries. The energy source 111 is removable from the tool box 1 and configured to supply power to the cleaning apparatus 1. To facilitate the process of cleaning a large surface, such as the exterior surfaces of a high-speed train vehicle, it requires the power supply of the cleaning apparatus 1 to support at least a couple hours in operation state. In one or more examples, the tool box 100 may include four groups of 48 V-180 ah lithium batteries to supply the power to the cleaning apparatus. Other compatible batteries may also work with the toolbox and the cleaning apparatus 1.

In some examples, an alarm light 130 may be disposed on the top side 101 of the tool box 100. The alarm light may indicate an operation state of the cleaning apparatus, such as whether the cleaning apparatus is in the working state or it is in an idle state.

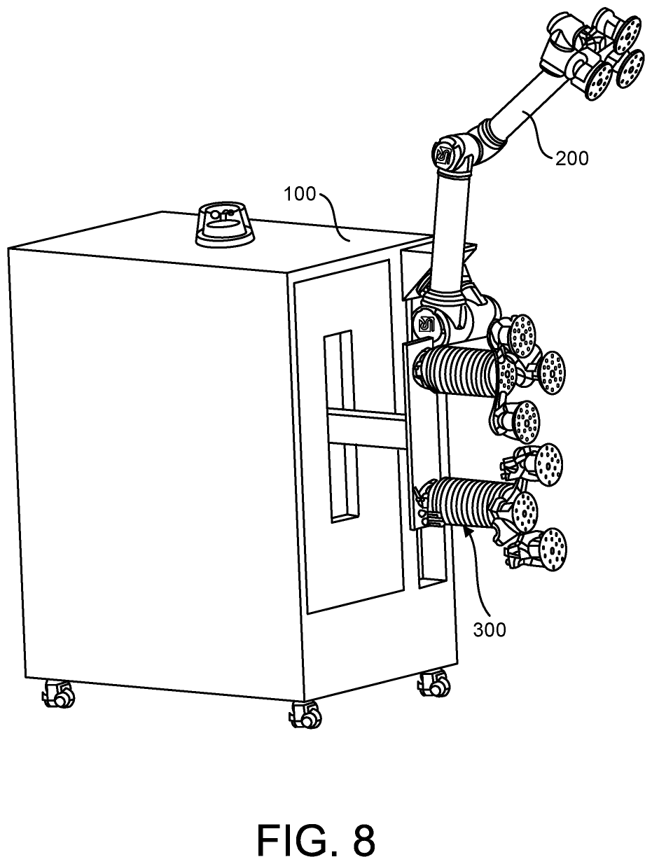

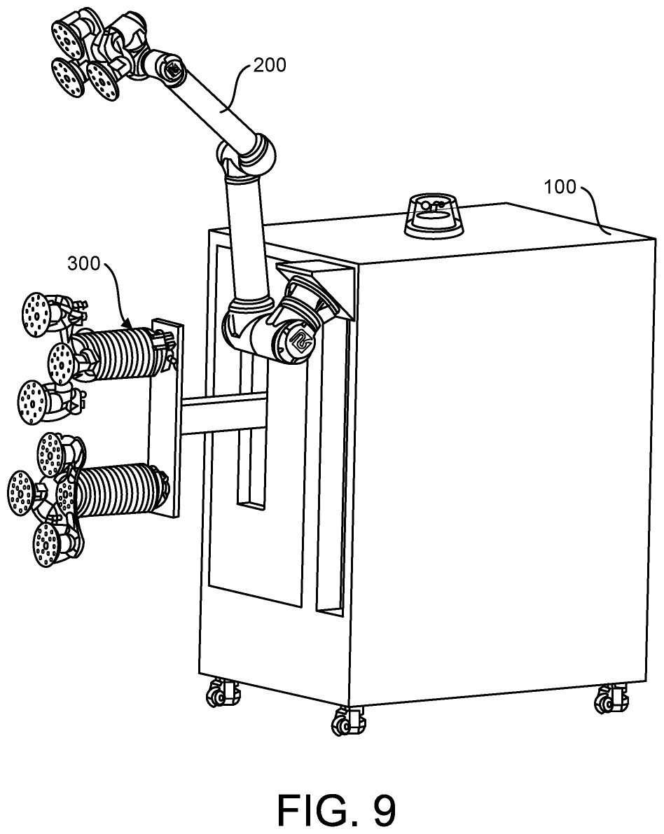

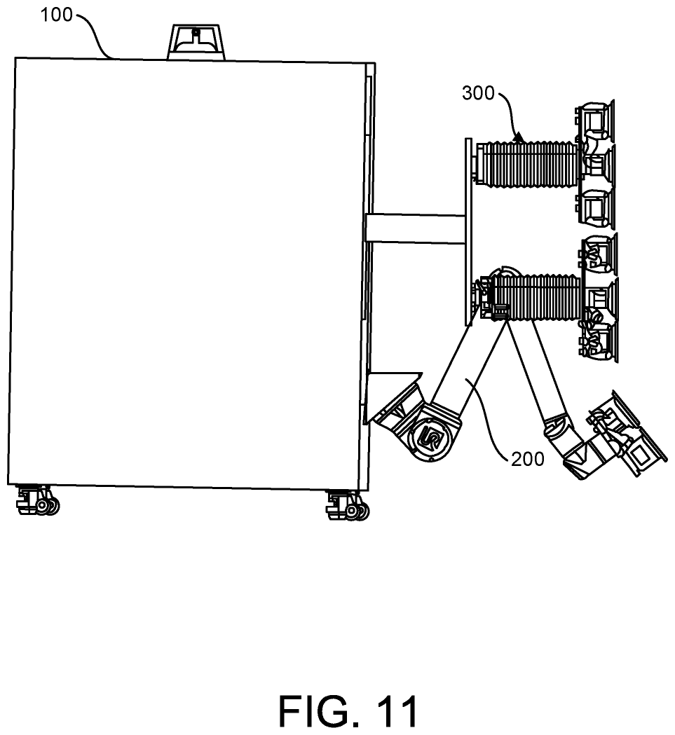

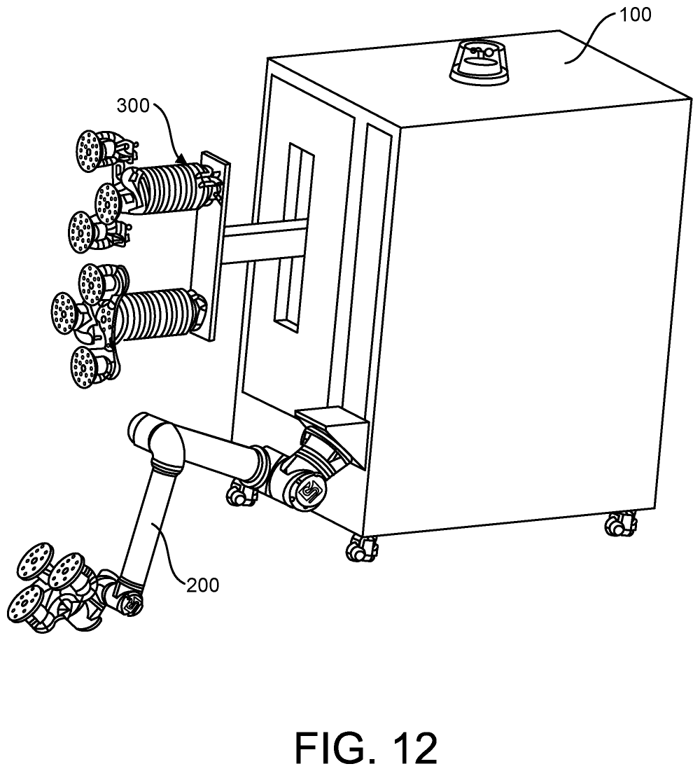

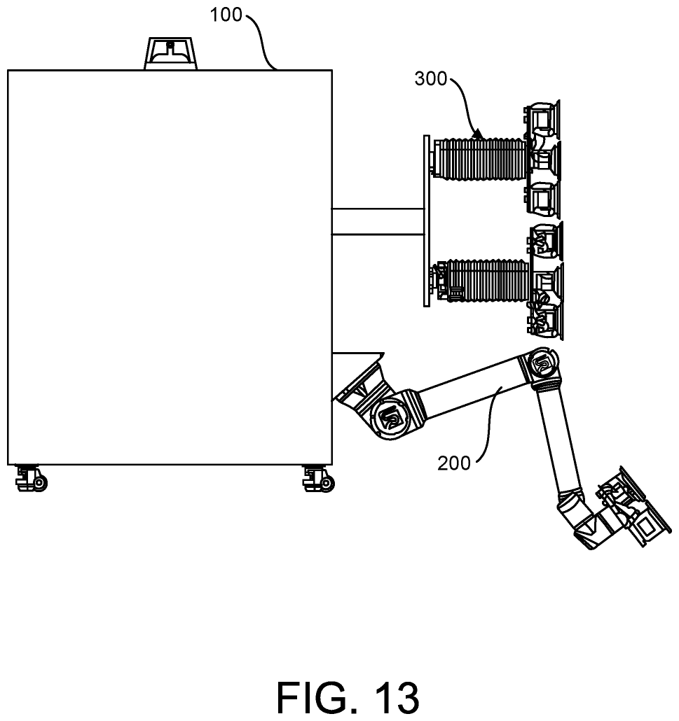

In some examples, multiple wheels 140 may be attached to the bottom side 102 of the tool box 100. As shown in FIGS. 1-13, four groups of wheel assemblies are provided and attached to the bottom side of the tool box to facilitate moving of the cleaning apparatus.

The tool box 1 may also include multiple control boxes, 112, 113, 114, and the control boxes are configured to control the movements and operations of the robot arm 200, the active contact flange 300, actuators, etc.

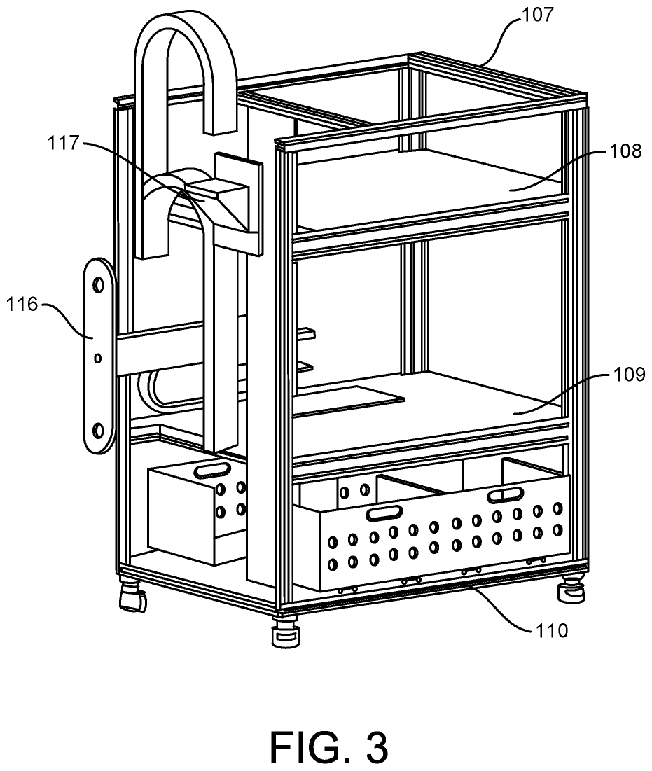

FIG. 3 shows a framework skeleton of the tool box 1, where all the batteries, processors, and other elements are detached and removed from the tool box 1. The overall skeleton frame 107 of the tool box 100 is made of aluminum alloy, and consists of three level racks 108, 109, 110 to accommodate the batteries, the processor, and various other elements inside the tool box. A T-shaped arm 116 protrudes from one side of the tool box frame, and is configured to attached to the active contact flange 300. The T-shaped arm 116 is configure to slide up and down along the height length of the tool box. Another connection arm 117 is also disposed next to the T-shaped arm 116 on the same side of the tool box 100. The connection arm 117 is provided to connect with the robot arm 200, and the connection arm is configured to move up and down along the height length of the tool box 100.

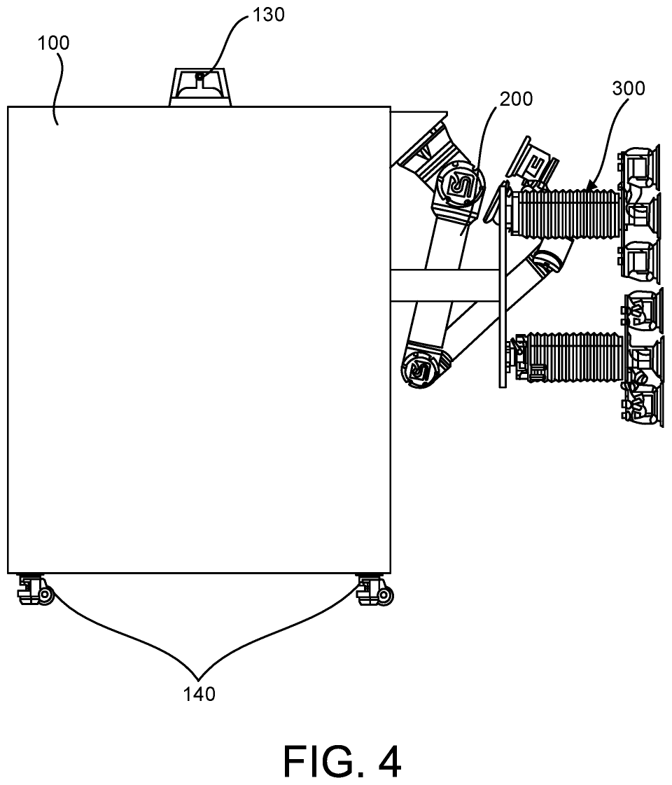

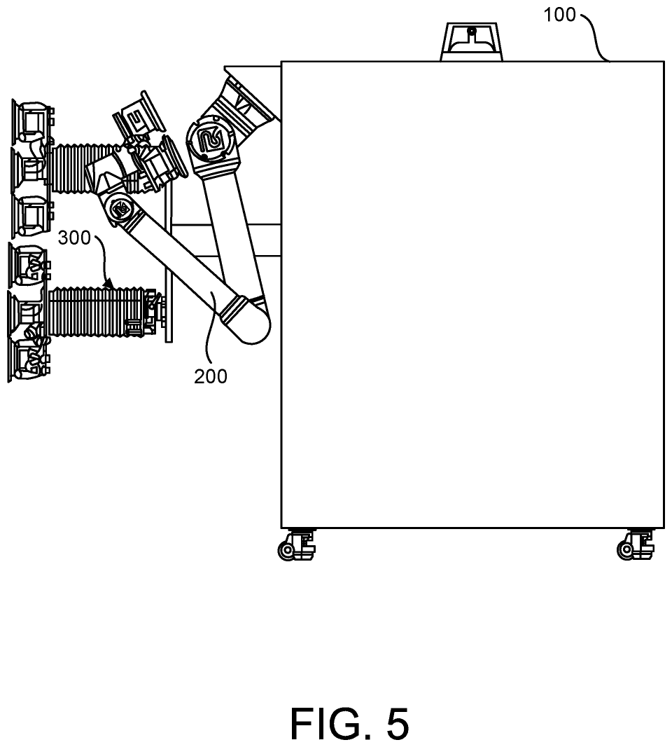

FIG. 4 and FIG. 5 show two side views of the cleaning apparatus in the idle state, including the tool box 100, the robot arm 200, and the active flange 300. When the cleaning apparatus is in the idle or resting state, the power supply is switched off, and robot arm 200 and the active contact flange 300 are both retracted, where they are in a more compact state for transportation or storage.

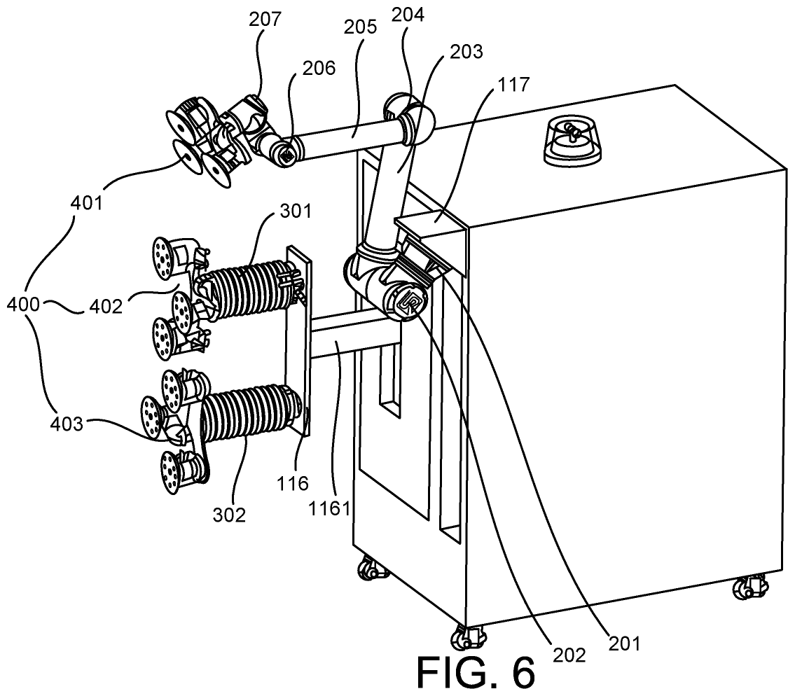

FIG. 6 illustrates a perspective view of the cleaning apparatus in accordance with some examples of the present disclosure. In some examples, the robot arm 200 may be collaborative robots (COBOT), and is configured to connect with the orbital kits 400 to carry out the sanding, polishing and waxing process during a cleaning operation on a curved and sophisticated surface. For large flat surfaces, the robot arm 200 may or may not be used.

In one example, the robot arm 200 may include at least two arm rods 203, 205, which are hingedly connected to each other and to the connection arm 17 of the tool box 1. At least three pairs of 202, 240, 206 hinges are provided in one robot arm 200 to allow vertical and horizontal movements of the robot arm 200. The robot arms with at least three pairs of hinges may allow it reach a desirable height and cover a larger curved surfaces for the cleaning operation. The hinge connection and the arm rods configuration allow the robot arm 200 to extend and retract during the cleaning process. The highest point that the robot arm 200 can reach in its fully-extended state should be higher than the maximum height of a high-speed vehicle. One end, the first end, of the robot arm 200 is connected to the connection arm 117 of the tool box 100, and the robot arm 200 may slide up and down along a first groove on the tool box. The other end, the second end, of the robot arm 200 is connected with one orbital kit 401. Alternatively, the first end of the robot arm 200 may be slidably connected to the first groove of the tool box 100.

The active contact flange 300 ensures and provides active contacts and constant force throughout the sanding, polishing, waxing operations. In one example, the active contact flange 3 may include two flange arms, the first flange arm 301 and the second flange arm 302. One end of the first flange arm 301 and the second flange arm 302 are connected to the T-shaped arm 116 of the tool box 1. The active contact flange may slide up and down along a second groove on the tool box 100. The other end of the two flange arms is connected to one orbital kit 402, 403 respectively. The two flange arms 301, 302 are vertically aligned along the T-shaped arm, and the two orbital kits 402, 403 are disposed on the second end of the active flange vertically next to each other. Alternatively, the first end of the active contact flange may be slidably connected to the second groove of the tool box 100. The orbital kit 4 includes orbital sander head and related parts according to some examples of the present disclosure. The orbital kit is used for major sanding, polishing and waxing operations. The sanding, polishing and waxing operations may be performed with certain compounds. Each of the orbital kits 401, 402, 403 may include three sander heads for sanding, polishing and waxing the exterior surfaces of a high-speed vehicle. In some cases, for large flat surfaces, the robot arm 200 may not be used. In such cases, multiple active contact flanges and orbital kits matrix may be used to clean large flat surfaces. In some other cases, the robot arm 200 may also operate to clean a large flat surface.

The present disclosure also provides an automated system for cleaning object surfaces, such as exterior surfaces of a high-speed train vehicle, etc. The automated system includes one or more sensors, a carrier, and a cleaning apparatus as described in the present disclosure. The one or more sensors are configured to scan object surfaces of a high-speed vehicle and obtain scanning data of the object surfaces. The carrier is configured to and lift a cleaning apparatus for sanding, polishing and waxing.

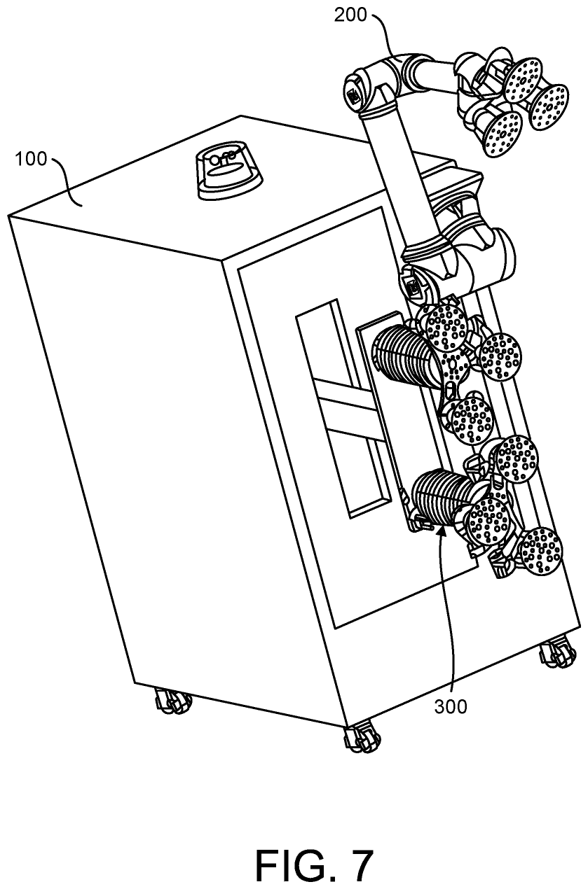

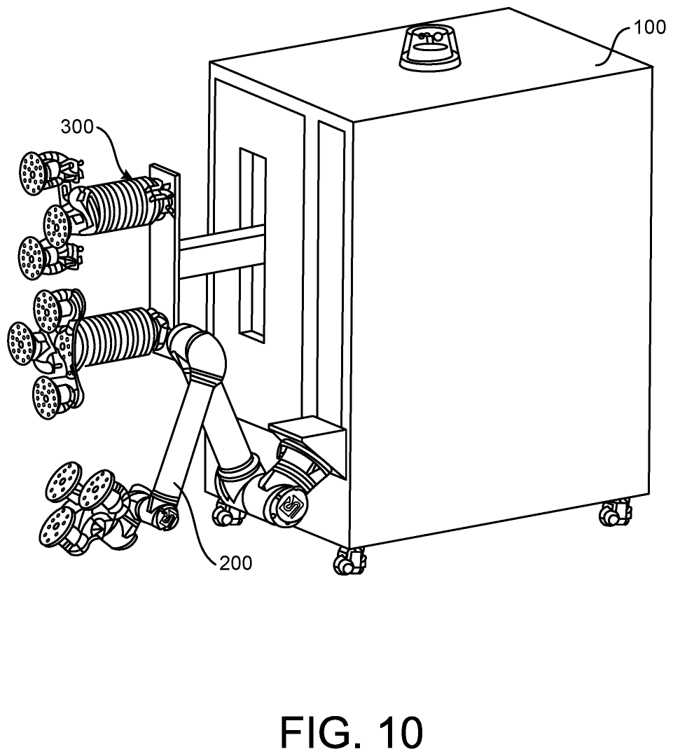

FIGS. 7-13 illustrate the cleaning apparatus in various working states in accordance with some implementations of the present disclosure. In order to reach different angles and different heights of a curved exterior object surface, the cleaning apparatus 1 including the tool box 100 may be tilted to a desirable angle in the working state. The robot arm 200 may extend, retract, slide up or slide down along the installation groove in the working state, to reach and cover the object surface to be cleaned. For example, as shown in FIGS. 7-9, the robot arm 200 slides up along the installation groove and extends to reach a higher position; and as shown in FIGS. 10-13, the robot arm 200 slides down along the installation groove and retracts or extends to reach a lower position. The active contact flange 300 may extend, retract, slide up or slide down along the installation groove in the working state, to provide active contact and constant force against the object surface to be cleaned.

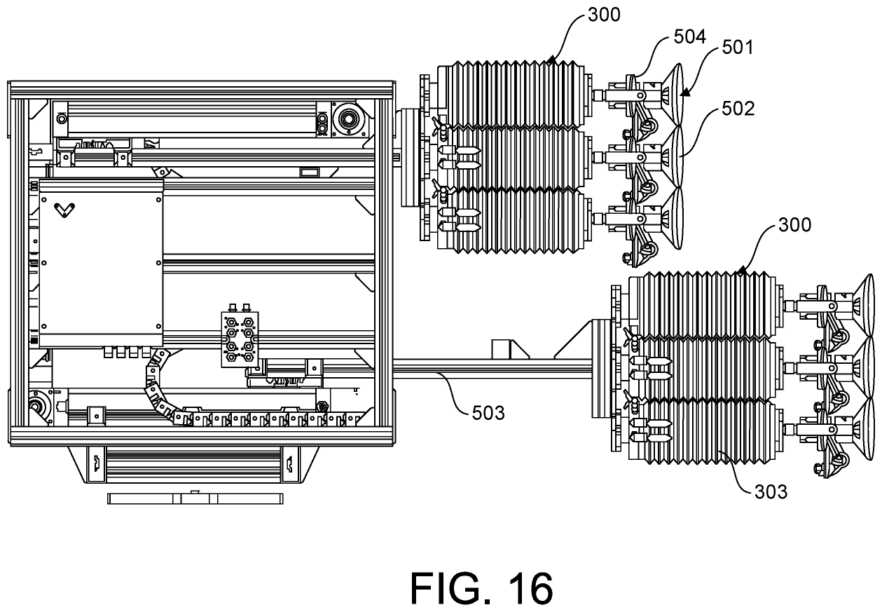

In some embodiments, as shown in FIGS. 16, the cleaning apparatus may include a plurality of active contact flanges 300, distributed on a side wall of the tool box. The plurality of active contact flanges 300 may be arranged to correspond to different areas of the high-speed vehicle to be cleaned, so that the high-speed vehicle can be cleaned more thoroughly. In some embodiments, as shown in FIGS. 16, the cleaning apparatus may include two active contact flanges 300, arranged to correspond to an upper area and a lower area of the high-speed vehicle. However, the number and the arrangement of the plurality of active contact flanges 300 are not limited to the embodiments of the present disclosure.

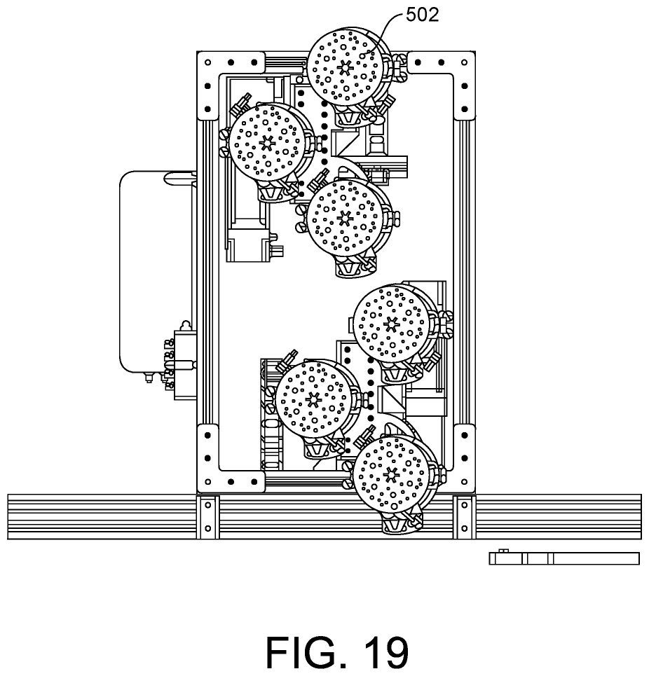

In some embodiments, as shown in FIGS. 16, each of the plurality of active contact flanges 300 may include a plurality of flange arms 303, and each of the plurality of flange arms 303 is connected to one orbital kit 501 which includes one sander head 502 for sanding, polishing and waxing the high-speed vehicle. In this case, each sander head 502 can be independently supported by one flange arm, so that each sander head 502 can have independent active contact and independent constant force, which can further improve the cleaning effect of the curved surface of the high-speed vehicle. In some embodiments, as shown in FIG. 19, each active contact flange 300 includes three flange arms 303, and each flange arms 303 is connected to one orbital kit 501 which includes one sander head 502. However, the number of the flange arms 303 included in each active contact flange 300 is not limited to the embodiments of the present disclosure.

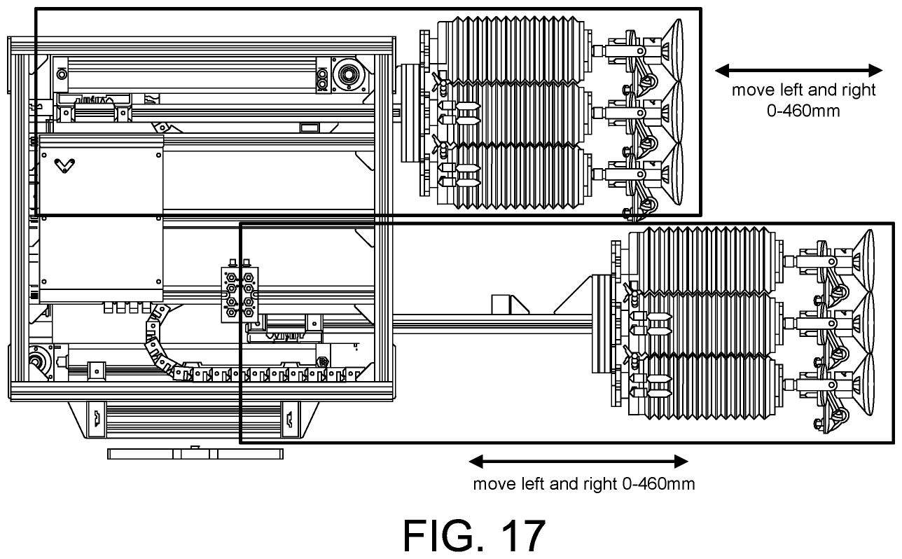

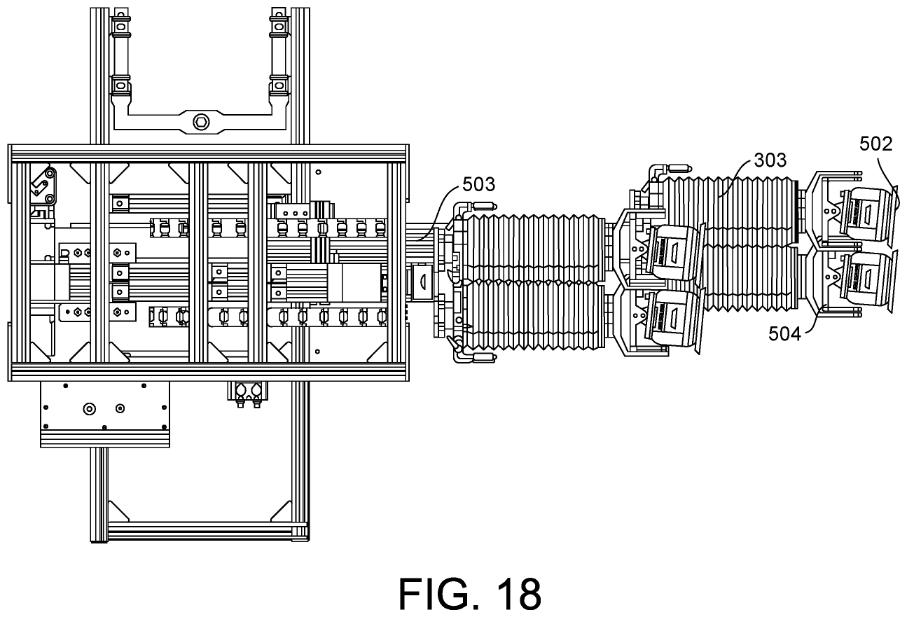

In some embodiments, as shown in FIGS. 16, the cleaning apparatus may further include a plurality of extending adjustment mechanisms 503, connecting to the tool box and configured to adjust extending distances of the plurality of active contact flanges 300 from the side wall of the tool box, respectively. By using the plurality of extending adjustment mechanisms 503, the extending distances of the plurality of active contact flanges 300 can be adjusted to more appropriately fit with the curved surface of the high-speed vehicle, which can further improve the cleaning effect. For example, as shown in FIG. 18, there are two active contact flanges 300 extending from the side wall of the tool box, one of the two active contact flange 300 extends further than the other one does, so that the two active contact flanges 300 can fit more appropriately fit with the curved surface of the high-speed vehicle. In some embodiments, the extending adjustment mechanism 503 may be powered by the energy source of the tool box, and may use a lead screw structure or a conveyor belt structure to drive the extending/retrieving movement of the active contact flange. In some embodiments, the extending distance may range from 0 to 460 mm, as shown in FIG. 17. However, the internal structure of the extending adjustment mechanism 503 and the extending distance range are not limited to the embodiments of the present disclosure.

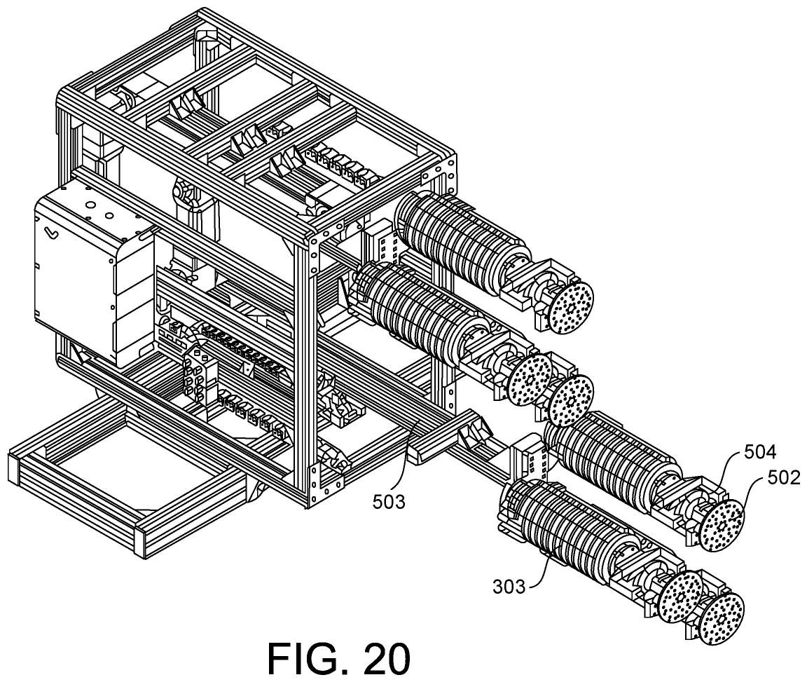

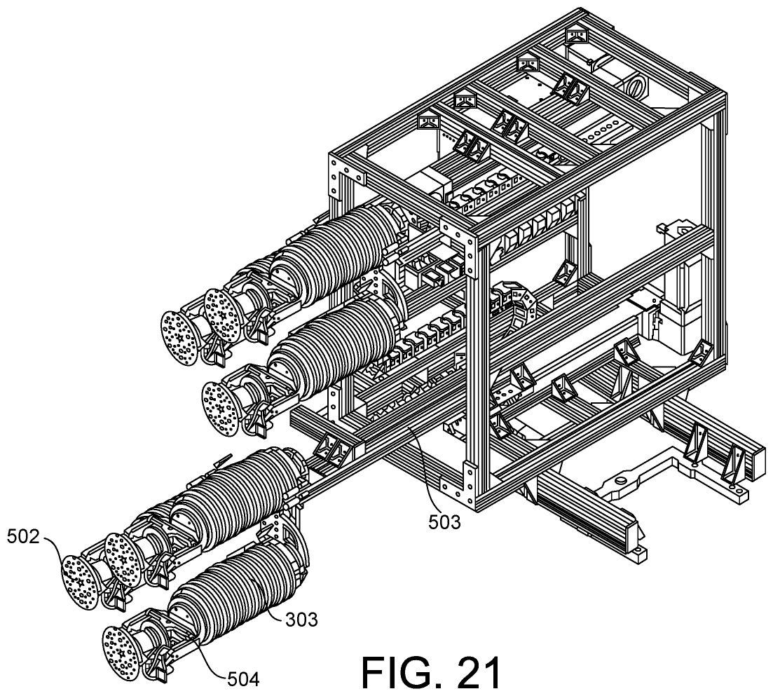

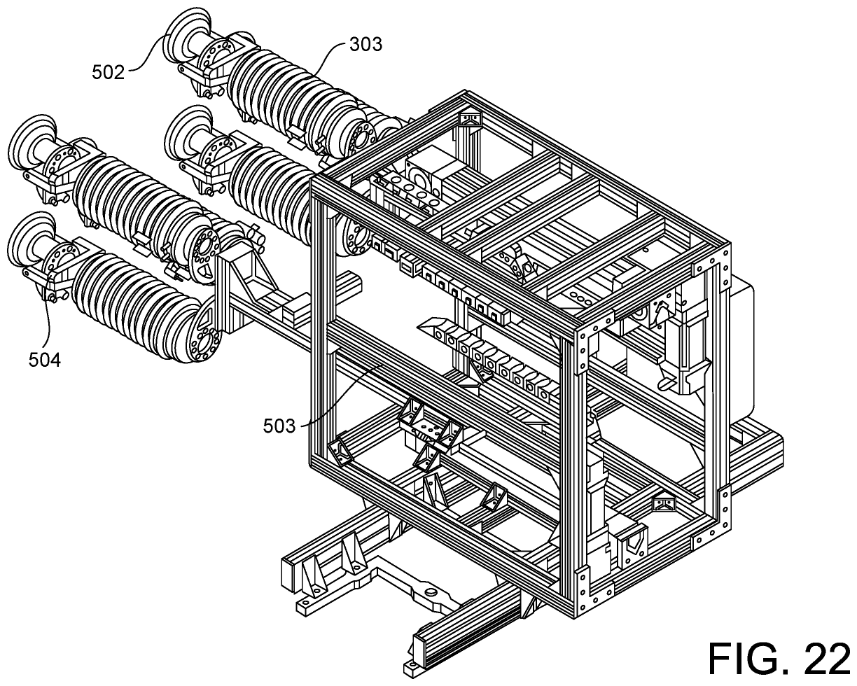

In some embodiments, as shown in FIGS. 20-22, an active contact flange of the at least one active contact flange may include an angle adjustment mechanism 504, connecting to the tool box and configured to adjust a tilting angle of a sander head 502 of an orbital kit 501 relative to a surface of the high-speed vehicle. By using the angle adjustment mechanism 504, the sander head 502 of the orbital kit 501 can be adjusted to more appropriately fit with the curved surface of the high-speed vehicle, which can further improve the cleaning effect. In some embodiments, as shown in FIGS. 21-22, the angle adjustment mechanism 504 may be connected to the processor to get instructions for the angle adjustment, or be connected to the energy source in the tool box.

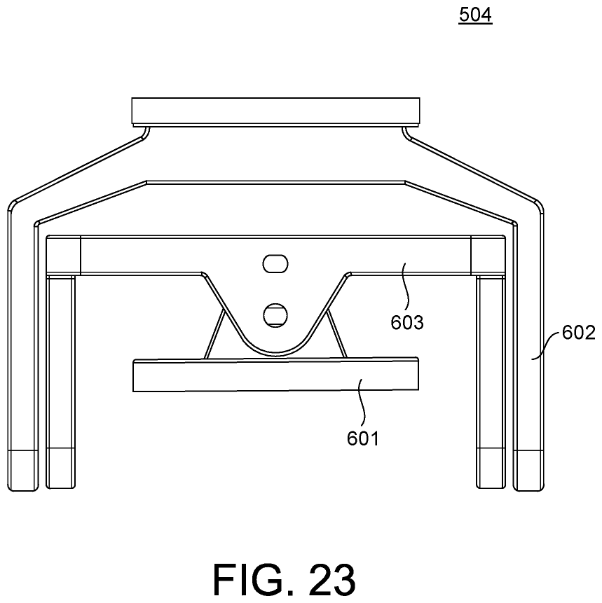

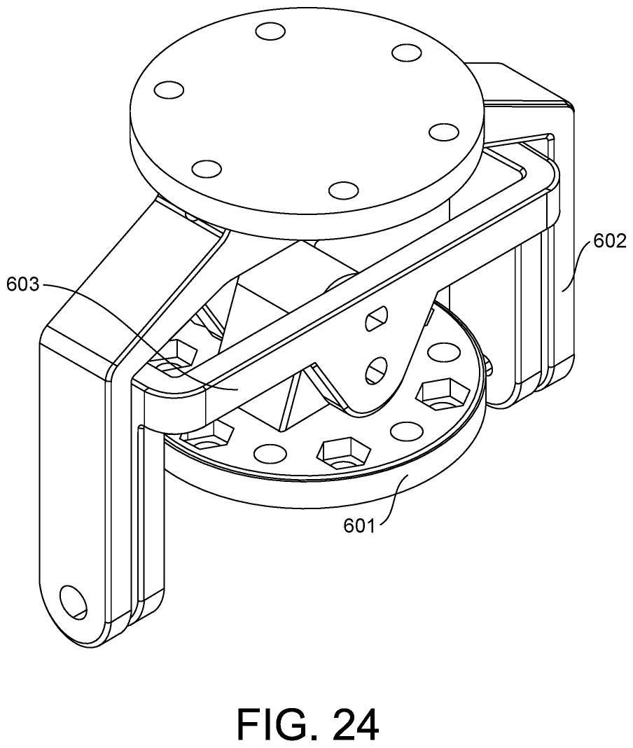

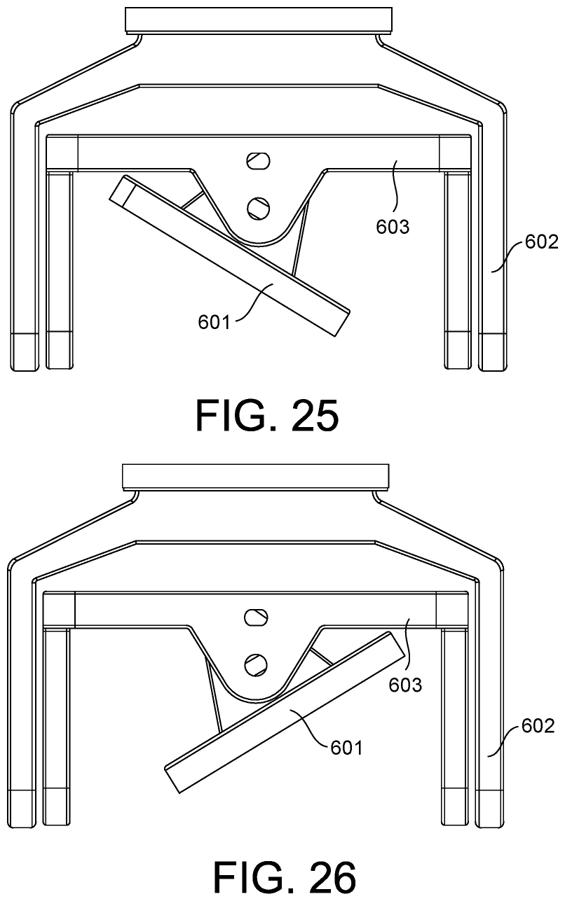

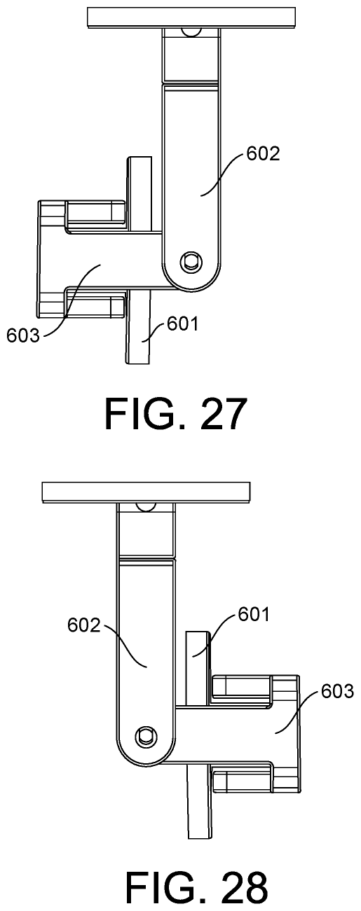

In some embodiments, as shown in FIGS. 23-24, the angle adjustment mechanism 504 may include a connecting flange 601, a first rotating arm 602, and a second rotating arm 603. The connecting flange 601 is configured to connect the sander head 502 of the orbital kit 501, the first rotating arm 602 is configured to rotate relative to a second rotating arm 603 via a first axis, and the second rotating arm 603 is configured to rotate relative to the connecting flange 601 via a second axis. The first axis is perpendicular to the second axis. For example, the connecting flange 601 can be adjusted to tilt 45 degrees left (FIG. 25), or tilt 45 degree right (FIG. 26); and the second rotating arm 603 can be adjusted to tilt 90 degrees left (FIG. 27), or tilt 90 degree right (FIG. 28). In some embodiments, both the first rotating arm 602 and the second rotating arm 603 may have arch structures, and the legs of the arch structure of the second rotating arm 603 rotates relative to the legs of the arch structure of the first rotating arm 602. However, the internal structure of the angle adjustment mechanism 504 is not limited to the embodiments of the present disclosure.

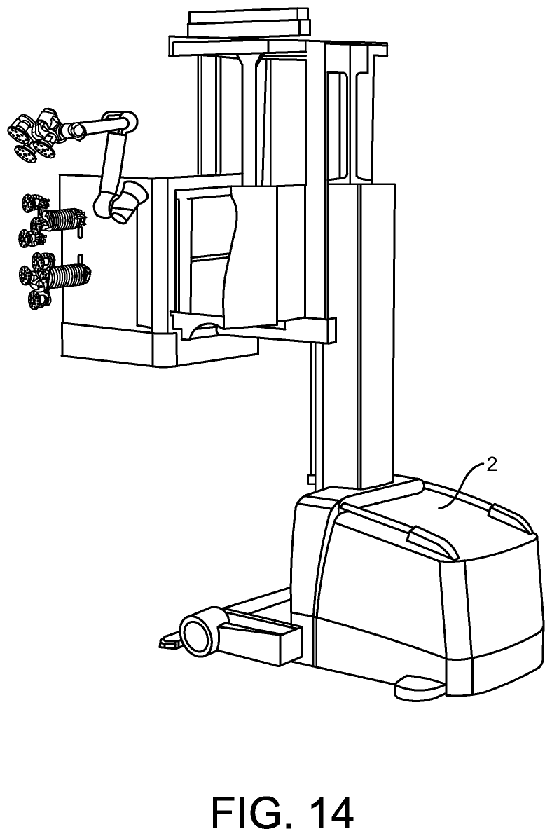

FIG. 14 shows an automated system for cleaning the object surfaces in accordance with some examples of the present disclosure. The cleaning apparatus is carried and lifted by a forklift of a carrier vehicle 2 in the operation of sanding, polishing and waxing. The orbital kits attached to the active contact flange are provided to clean large flat surfaces, and the robot arm is to provide extended reach and different angles for sanding, polishing and waxing curved surfaces.

In some examples of the present disclosure, the automated cleaning system may also include a scan subsystem. The scan subsystem is configured to the scan object surfaces and send the scanning data to central processing unit for data processing.

In some examples, the automated cleaning system is also equipped with a carrier subsystem. The carrier subsystem may be an automated guided vehicle (AGV), or a carrier vehicle with lift, or any other compatible carrier vehicle. The carrier subsystem is configured to carry and lift the cleaning apparatus 1 and other subsystems during the operation of the cleaning process. The carrier system may carry and lift the cleaning apparatus to a certain desirable height to perform the cleaning operations.

The automated cleaning system may also include a central processing unit, such as one or multiple processors. The processor may typically control overall operations of the cleaning apparatus and the automated system, such as receiving scanning data, generating working paths and to coordinating among sub-systems. The processor may include one or more processors to execute instructions to perform all or some of the steps in the above-described methods. Moreover, the processor may include one or more modules that facilitate the interaction between the processor and other components. The processor may be a Central Processing Unit (CPU), a microprocessor, a single chip machine, a Graphical Processing Unit (GPU), or the like.

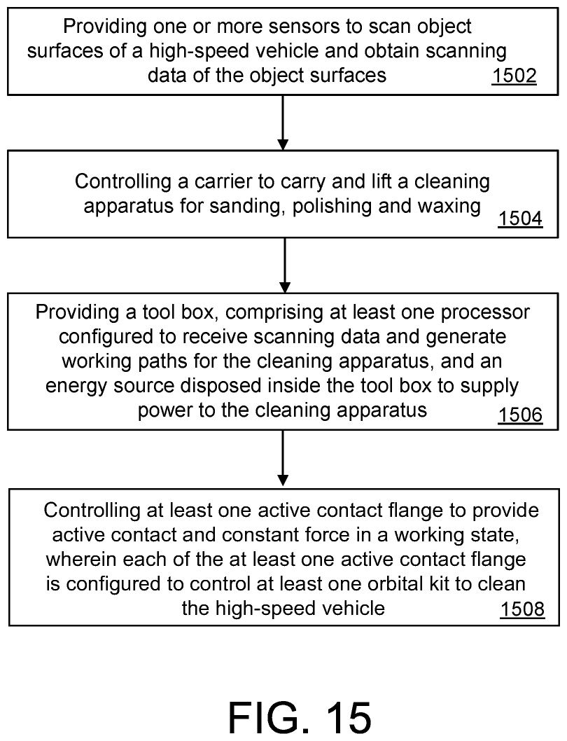

FIG. 15 is a block diagram illustrates a method for cleaning object surfaces in accordance with some implementations of the present disclosure. In Step 1502, one or more sensors to scan object surfaces of a high-speed vehicle and obtain scanning data of the object surfaces may be provided. In Step 1504, the carrier to carry and lift a cleaning apparatus is controlled for sanding, polishing and waxing. In Step 1506, a tool box is provided, and the tool box includes at least one processor configured to receive scanning data and generate working paths for the cleaning apparatus, and an energy source disposed inside the tool box to supply power to the cleaning apparatus. In Step 1508, at least one active flange is controlled to provide active contact and constant force in a working state of the cleaning apparatus.

In some embodiments, the method further includes controlling a robot arm to clean the object surfaces of the high-speed vehicle.

In some embodiments, the cleaning apparatus includes a plurality of active contact flanges, distributed on a side wall of the tool box, and the method further includes: controlling a plurality of extending adjustment mechanisms to adjust extending distances of the plurality of active contact flanges from the side wall of the tool box, respectively.

In some embodiments, the method further includes controlling an angle adjustment mechanism to adjust a tilting angle of a sander head of an orbit kit relative to a surface of the high-speed vehicle.

The description of the present disclosure has been presented for purposes of illustration and is not intended to be exhaustive or limited to the present disclosure. Many modifications, variations, and alternative implementations will be apparent to those of ordinary skill in the art having the benefit of the teachings presented in the foregoing descriptions and the associated drawings.

Unless specifically stated otherwise, an order of steps of the method according to the present disclosure is only intended to be illustrative, and the steps of the method according to the present disclosure are not limited to the order specifically described above, but may be changed according to practical conditions. In addition, at least one of the steps of the method according to the present disclosure may be adjusted, combined or deleted according to practical requirements.

The examples were chosen and described in order to explain the principles of the disclosure and to enable others skilled in the art to understand the disclosure for various implementations and to best utilize the underlying principles and various implementations with various modifications as are suited to the particular use contemplated. Therefore, it is to be understood that the scope of the disclosure is not to be limited to the specific examples of the implementations disclosed and that modifications and other implementations are intended to be included within the scope of the present disclosure.

What is claimed is:

1. A cleaning apparatus, comprising:
a tool box, comprising at least one processor configured to receive scanning data and generate working paths for the cleaning apparatus, and an energy source disposed inside the tool box to supply power to the cleaning apparatus; and
at least one active contact flange, connecting to the tool box and configured to provide active contact and constant force in a working state, each of the at least one active contact flange configured to control at least one orbital kit to clean the high-speed vehicle.

2. The cleaning apparatus of claim 1, wherein a side wall of the tool box comprises a first groove and a second groove, and the cleaning apparatus comprises:
a robot arm, connecting to the tool box and configured to slide along the first groove of the tool box, the robot arm configured to control a first orbital kit to clean a high-speed vehicle parked in a cleaning station; and
an active contact flange, configured to control a second orbital kit to clean the high-speed vehicle with the second orbital kit.

3. The cleaning apparatus of claim 1, further comprising:
an alarm light disposed on a top surface of the tool box that indicates an operation state of the cleaning apparatus, wherein the operation state comprises the working state and an idle state of the cleaning apparatus.

4. The cleaning apparatus of claim 1, further comprising:
a plurality of wheel assemblies attached to a bottom surface of the tool box to facilitate moving of the cleaning apparatus.

5. The cleaning apparatus of claim 1, wherein the robot arm further comprises a plurality of arm rods, and a plurality of hinges to connect the plurality of arm rods to allow the robot arm to extend and retract, wherein a reach height of the collaborative robot arm is higher than a maximum height of the high-speed vehicle in a fully-extended state.

6. The cleaning apparatus of claim 1, wherein a first end of the robot arm is slidably connected to the first groove, a first end of the active contact flange is slidably connected to the second groove, the first orbital kit is connected to a second end of the robot arm, and the second orbital kit is connected to a second end of the active contact flange.

7. The cleaning apparatus of claim 6, wherein the second end of the active contact flange is connected to two orbital kits, and the two orbital kits are disposed on the second end of the active flange vertically next to each other.

8. The cleaning apparatus of claim 1, wherein the energy source comprises a plurality of lithium batteries.

9. The cleaning apparatus of claim 1, wherein each of the first orbital kit and the second orbital kit comprises a plurality of sander heads for sanding, polishing and waxing the high-speed vehicle.

10. The cleaning apparatus of claim 1, comprising:
a plurality of active contact flanges, distributed on a side wall of the tool box.

11. The cleaning apparatus of claim 10, wherein each of the plurality of active contact flanges comprises a plurality of flange arms, each of the plurality of flange arms connected to one orbital kit which comprises one sander head for sanding, polishing and waxing the high-speed vehicle.

12. The cleaning apparatus of claim 10, further comprising:
a plurality of extending adjustment mechanisms, connecting to the tool box and configured to adjust extending distances of the plurality of active contact flanges from the side wall of the tool box, respectively.

13. The cleaning apparatus of claim 1, an active contact flange of the at least one active contact flange comprises:
an angle adjustment mechanism, connecting to the tool box and configured to adjust a tilting angle of a sander head of an orbit kit relative to a surface of the high-speed vehicle.

14. The cleaning apparatus of claim 13, the angle adjustment mechanism comprises:
a connecting flange, configured to connect the sander head of the orbit kit;
a first rotating arm, configured to rotate relative to a second rotating arm via a first axis; and
a second rotating arm, configured to rotate relative to the connecting flange via a second axis;
wherein the first axis is perpendicular to the second axis.

15. An automated system, comprising:
one or more sensors to scan object surfaces of a high-speed vehicle and obtain scanning data of the object surfaces;
a carrier to carry and lift a cleaning apparatus for sanding, polishing and waxing; and
the cleaning apparatus, further comprising:
a tool box, comprising at least one processor configured to receive scanning data and generate working paths for the cleaning apparatus, and an energy source disposed inside the tool box to supply power to the cleaning apparatus; and
at least one active contact flange, connecting to the tool box and configured to provide active contact and constant force in a working state, each of the at least one active contact flange configured to control at least one orbital kit to clean the high-speed vehicle.

16. The automated system of claim 15, wherein a side wall of the tool box comprises a first groove and a second groove, and the cleaning apparatus comprises:
a robot arm, connecting to the tool box and configured to slide along the first groove of the tool box, the robot arm configured to control a first orbital kit to clean the high-speed vehicle parked in a cleaning station; and
an active contact flange, connecting to the tool box and configured to slide along the second groove of the tool box to provide active contact and constant force in a working state, the active contact flange configured to control a second orbital kit to clean the high-speed vehicle with the second orbital kit.

17. The automated system of claim 15, further comprising:
an alarm light disposed on a top surface of the tool box that indicates an operation state of the cleaning apparatus, wherein the operation state comprises the working state and an idle state of the cleaning apparatus.

18. The automated system of claim 15, further comprising:
a plurality of wheel assemblies attached to a bottom surface of the tool box to facilitate moving of the cleaning apparatus.

19. The automated system of claim 15, wherein the robot arm further comprises a plurality of arm rods, and a plurality of hinges to connect the plurality of arm rods to allow the robot arm to extend and retract, wherein a reach height of the collaborative robot arm is higher than a maximum height in a fully-extended state.

20. The automated system of claim 15, wherein a first end of the robot arm is slidably connected to the first groove, a first end of the active contact flange is slidably connected to the second groove, the first orbital kit is connected to a second end of the robot arm, and the second orbital kit is connected to a second end of the active contact flange.

21. The automated system of claim 20, wherein the second end of the active contact flange is connected to two orbital kits, and the two orbital kits are disposed on the second end of the active flange vertically next to each other.

22. The automated system of claim 15, wherein the energy source comprises a plurality of lithium batteries.

23. The automated system of claim 15, wherein each of the first orbital kit and the second orbital kit comprises a plurality of sander heads for sanding, polishing and waxing the high-speed vehicle.

24. The automated system of claim 15, wherein the cleaning apparatus comprises:
a plurality of active contact flanges, distributed on a side wall of the tool box.

25. The automated system of claim 24, wherein each of the plurality of active contact flanges comprises a plurality of flange arms, each of the plurality of flange arms connected to one orbital kit which comprises one sander head for sanding, polishing and waxing the high-speed vehicle.

26. The automated system of claim 24, wherein the cleaning apparatus further comprises:
a plurality of extending adjustment mechanisms, connecting to the tool box and configured to adjust extending distances of the plurality of active contact flanges from the side wall of the tool box, respectively.

27. The automated system of claim 15, an active contact flange of the at least one active contact flange comprises:
an angle adjustment mechanism, connecting to the tool box and configured to adjust a tilting angle of a sander head of an orbit kit relative to a surface of the high-speed vehicle.

28. The automated system of claim 27, the angle adjustment mechanism comprises:
a connecting flange, configured to connect the sander head of the orbit kit;
a first rotating arm, configured to rotate relative to a second rotating arm via a first axis; and
a second rotating arm, configured to rotate relative to the connecting flange via a second axis;
wherein the first axis is perpendicular to the second axis.

29. A method for cleaning object surfaces, comprising:
providing one or more sensors to scan object surfaces of a high-speed vehicle and obtain scanning data of the object surfaces;
controlling a carrier to carry and lift a cleaning apparatus for sanding, polishing and waxing;
providing a tool box, comprising at least one processor configured to receive scanning data and generate working paths for the cleaning apparatus, and an energy source disposed inside the tool box to supply power to the cleaning apparatus; and
controlling at least one active contact flange to provide active contact and constant force in a working state, wherein each of the at least one active contact flange is configured to control at least one orbital kit to clean the high-speed vehicle.

30. The method of claim 29, wherein a side wall of the tool box comprises a first groove and a second groove, and the method further comprises:
controlling a robot arm to clean the object surfaces of the high-speed vehicle, wherein the robot arm is connected to the tool box and configured to slide along the first groove of the tool box, and the robot arm is configured to control a first orbital kit to clean the high-speed vehicle parked in a cleaning station;
wherein an active contact flange is connected to the tool box and configured to slide along the second groove of the tool box, and the active contact flange is configured to control a second orbital kit to clean the high-speed vehicle with the second orbital kit.

31. The method of claim 30, wherein each of the first orbital kit and the second orbital kit comprises a plurality of sander heads for sanding, polishing and waxing the high-speed vehicle.

32. The method of claim 29, further comprising:
providing an alarm light disposed on a top surface of the tool box that indicates an operation state of the cleaning apparatus, wherein the operation state comprises the working state and an idle state of the cleaning apparatus.

33. The method of claim 29, further comprising:
providing a plurality of lithium batteries as the energy source for the cleaning apparatus.

34. The method of claim 29, wherein the cleaning apparatus comprises a plurality of active contact flanges, distributed on a side wall of the tool box, and the method further comprises:
controlling a plurality of extending adjustment mechanisms to adjust extending distances of the plurality of active contact flanges from the side wall of the tool box, respectively.

35. The method of claim 29, further comprising:
controlling an angle adjustment mechanism to adjust a tilting angle of a sander head of an orbit kit relative to a surface of the high-speed vehicle.
